(19) United States
(12) Patent Application Publication
(10) Pub. No.: US 2005/0008742 A1
(43) Pub. Date: Jan. 13, 2005

(54) Method of providing grill marks on a foodstuff

(76) Inventors: Luke Griesbach, Manitowoc, WI (US); Ronald J. Foster, Appleton, WI (US); Melissa Ventura, Belgium, WI (US); Jeffrey J. Rozum, Cato, WI (US); Brian Hickman, Green Bay, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/888,860

(22) Filed: Jul. 9, 2004

Related U.S. Application Data
(60) Provisional application No. 60/486,342, filed on Jul. 11, 2003.

(51) Int. Cl. A23P 1/00

(52) U.S. Cl. 426/383

(57) ABSTRACT

A method of providing grill marks on a food product is disclosed. A food colorant is applied to a surface of a foodstuff in a predetermined pattern. The pattern typically is undetectable until the foodstuff is heated or cooked, at which time the pattern is observable as esthetically pleasing grill marks. In some embodiments, the grill marks also impart a flavor to the heated or cooked foodstuff.

### CROSS-REFERENCE TO RELATED APPLICATION

This application claims the benefit of provisional U.S. Patent Application Ser. No. 60/486,342, filed Jul. 11, 2003.

### FIELD OF THE INVENTION

The present invention is directed to foodstuffs having an esthetically pleasing pattern of grill marks on at least one surface of the foodstuff. More particularly, the present invention is directed to a method wherein a food colorant is applied to at least one surface of a foodstuff in a predetermined pattern. The pattern typically is undetectable until the foodstuff is heated or cooked. In some embodiments, the grill marks also impart a flavor to the foodstuff.

### BACKGROUND OF THE INVENTION

Consumers often desire an esthetically pleasing pattern of grill marks on a foodstuff. The grill marks provide a more appetizing appearance to the foodstuff, and give the appearance that the foodstuff has been grilled. Swaidner et al. U.S. Pat. No. 5,762,968, incorporated herein by reference, provides additional reasons why consumers prefer an appearance of a grilled foodstuff, and a method of imparting grill marks onto a foodstuff without grilling.

Previously, the only ways to impart grill marks to a foodstuff was to actually grill the foodstuff, or to apply a hot brand to the foodstuff during or shortly after cooking. Grilling often is not the easiest method of cooking or heating a foodstuff, and the grill marks typically are indefinite and of random design. Branding provides definite marks of a predetermined design, but has the disadvantage of requiring a hot brand and adding an additional step to the cooking or heating of a foodstuff.

The present invention is directed to a method of providing grill marks on a cooked or heated foodstuff that overcomes the disadvantages of branding, and avoids grilling.

### SUMMARY OF THE INVENTION

The present invention relates to foodstuffs having a predetermined pattern of grill marks on at least one surface of the foodstuff. More particularly, the present invention relates to a treated foodstuff wherein grill marks appear on at least one surface of the foodstuff, typically during heating or cooking of the foodstuff.

Therefore, one aspect of the present invention is to provide a foodstuff that lacks distinct grill marks until the foodstuff is heated or cooked. The grill marks appear in a predetermined pattern during heating or cooking of the foodstuff.

Another aspect of the present invention is to provide a method of imparting grill marks to a foodstuff, without the need to grill or brand the foodstuff. In particular, a food colorant is applied to a foodstuff in a predetermined pattern. The pattern typically is undetectable until the foodstuff is cooked or heated. During cooking or heating, the grill marks appear in a definite pattern. In some embodiments, the food colorant contains food flavoring agents that impart a food flavor, e.g., a grill or smoke flavor, to the foodstuff in addition to grill marks.

These and other novel aspects and advantages of the present invention will become apparent from the following detailed description of the preferred embodiments.

### DETAILED DESCRIPTION OF THE PREFERRED EMBODIMENT

It has long been a goal to impart grill marks to a foodstuff without the need to grill or brand a foodstuff. The present invention allows the generation of grill marks on a cooked or heated foodstuff in a predetermined pattern, regardless of the manner of heating or cooking the foodstuff. The present method permits the preparation of foodstuffs having grill marks in institutional and domestic kitchens to enhance the esthetics, and, if desired, the flavor, of the foodstuff.

In accordance with the present invention, a food colorant is applied to at least one surface of a foodstuff in a sufficient amount such that the food colorant becomes visible when the foodstuff is cooked or heated. The food colorant is applied in a predetermined pattern to provide an esthetically pleasing array of grill marks. Alternatively, the pattern can be a complex design, such as a name, logo, or other artistic design to convey a commercial or other message.

A foodstuff that can be treated in accordance with the present method is any foodstuff that is cooked or heated prior to serving. The foodstuff, therefore, can be either raw or precooked, and either fresh or frozen. Therefore, a frozen, precooked foodstuff, which later is reheated for consumption, can be treated to provide grill marks.

Nonlimiting examples of foodstuffs that can be treated to provide grill marks include, but are not limited to, seafood, such as shrimp, scallops, or fish of any type, e.g., cod, pollack, and tuna; chicken, including chicken parts and chicken patties; beef, including steaks and patties; pork, including pork chops and ribs; dough-based products, including pies, dinner rolls, biscuits, and bagels; toast; polenta; pet foods; snack foods; and cheeses.

Fresh or processed food can be treated in accordance with the present method. Processors can prepare the foodstuff for packaging, then apply the food colorant in a predetermined pattern. The foodstuff then can be frozen and later heated by the consumer, or the foodstuff can be cooked in a continuous processing cycle by the food processor prior to packaging. Thermal processing activates the food colorant and the grill marks appear as the foodstuff is heated. In embodiments where a food flavor also is applied to the foodstuff, the grill marks may be observable prior to thermal processing.

In embodiments wherein the food colorant is applied to a warm surface, the grill marks may become visually perceptible after application and prior to cooking and heating. In embodiments wherein a food colorant that generates color by a Maillard reaction is applied to a cold or frozen surface, the grill marks typically are undetectable, or essentially undetectable, to the human eye until the foodstuff is heated or cooked. By “essentially undetectable,” it is meant that an inspection of the foodstuff is required to observe the grill marks on an uncooked or unheated foodstuff, as opposed to a casual visual contact with the foodstuff.

The food colorant applied to the foodstuff can be any colorant suitable for application to edible items. Typically, the food colorant is the type that generates color by a Maillard reaction, i.e., reacts with a protein of the foodstuff during a heating process to form a brown to black color. Such food colorants differ from those that act as a dye, for example, a caramel color that merely dyes the foodstuff. However, dye-type food colorants also can be used in the present invention.

In particular, in institutional kitchens, any type of food colorant can be used because the consumer only views the cooked or heated foodstuff having grill marks. For domestic kitchens, food colorants that are undetectable until heating are preferred. In this case, the foodstuff is esthetic in its precooked or prewarmed state, and esthetic and appealing after cooking or heating.

Nonlimiting examples of food colorants useful in the present invention include the MAILLOSE® and CHARSOL® products, available from Red Arrow Products Co., LLC, Manitowoc, Wis. A food colorant useful to practice the present invention preferably contains hydroxyacetaldehyde (HAA). HAA imparts a golden brown color, and essentially no taste, to cooked or heated foodstuffs. The production and use of HAA are disclosed in Underwood et al. U.S. Pat. Nos. 5,292,541 and 5,397,592, and Stradal et al. U.S. Pat. No. 5,393,542, each incorporated herein by reference. Commercial sources of hydroxyacetaldehyde include MAILLOSE® Dry, MAILLOSE® liquid, MAILLOSE® 45, SELECT 24 P, CHARSOL® Supreme, or mixtures thereof, all available from Red Arrow Products LLC., Manitowoc, Wis. Such solutions/mixtures typically contain about 3% to about 25%, by weight, hydroxyacetaldehyde.

An HAA-containing food colorant can be used without dilution, or can be diluted with water. A preferred food colorant comprises about 0.02% to about 25% by weight HAA, and, more preferably, about 0.5% to about 25%, by weight HAA. To achieve the full advantage of the present invention, the food colorant contains about 1% to about 20% HAA, by weight. A sufficient amount of HAA is applied to the foodstuff to impart a rich golden brown color, in a predetermined pattern, to a heated or cooked foodstuff.

Compositions containing other food colorants also can be used in the present invention. For example, liquid smoke compositions, such as the CHARSOL® products available from Red Arrow Products LLC, Manitowoc, Wis., can be used to impart brown grill marks, and flavor, to the foodstuff.

These above food colorants, and other food colorants available from other suppliers, can be used as is or diluted. The food colorant, regardless of concentration, is applied in a sufficient amount to impart the desired degree of color to the foodstuff.

In addition, if desired, additional components can be added to the food colorant. For example, a grill flavor, a spice, or other food flavoring can be added to the food colorant prior to applying the food colorant to the foodstuff. In this embodiment, both a food colorant and a food flavoring are simultaneously applied to the foodstuff. In some cases, the food colorant contains flavoring ingredients, e.g., smoke flavors, for example the CHARSOL® brand smoke flavoring products available from Red Arrow Products Co., LLC. Standard liquid smoke compositions contain phenols and acids to impart a smokey flavor to the foodstuff, and contain carbonyl compounds to impart browning.

The food colorant also can contain other optional ingredients known to persons skilled in the art. For example, well known additives such as gums, thickeners, or preservatives, can be incorporated in the food colorant to provide a browning and flavoring most suitable for a particular type of foodstuff. In one embodiment, a dry MAILLOSE® product can be admixed with a maltodextrin, a food starch, a hydrolyzed collagen, and/or a food gum, and any other desired optional ingredients. Hollenbeck U.S. Pat. No. 3,106,473, Underwood et al. U.S. Pat. No. 4,876,108, and Stradal et al. U.S. Pat. No. 5,252,188, each incorporated herein by reference, are examples of patents that disclose food colorants that can be applied to a foodstuff to impart a golden brown color, and optionally, a smokey flavor to the foodstuff.

The food colorant is applied to the foodstuff in a predetermined pattern. The food colorant is applied to one or more surfaces of the foodstuff as desired. The predetermined pattern can be simple, e.g., straight lines, or more complex, e.g., a logo.

The food colorant is applied by noncontact methods, e.g., spraying, dripping, or gravity contact of a solid food colorant. Noncontact methods are utilized because of speed of application, complex patterns are more easily achieved, and risks of contaminating the foodstuff are reduced. As used herein, the term “noncontact” refers to an absence of contact between the foodstuff and the apparatus or equipment used to apply a food colorant to a foodstuff.

One preferred method of applying the food colorant is by spraying. Spraying provides a very precise spray pattern and a controlled distribution of the food colorant on the surface of the foodstuff. A variety of useful spray equipment is available from Spraying Systems Co., Wheaton, Ill.

Typical spray nozzles useful in the method of the present invention have an orifice diameter of about 0.008 to about 0.123 inches, and preferably about 0.008 to about 0.055 inches. Most preferably, the spray nozzle has an orifice of about 0.008 to about 0.023 inches. The spray nozzles are selected to deliver about 0.003 to about 2 gallons, preferably about 0.003 to about 1.1 gallons, and most preferably about 0.003 to about 0.35 gallons, of food colorant per minute over a pressure range of 3 to 1500 psi (pounds per square inch). The spray pressure preferably is about 3 to about 500 psi, and most preferably about 15 to about 200 psi. At pressures above about 500 psi, the force of the spraying can indent the foodstuff, and impart the visual effect of a grilled or branded foodstuff.

Another useful spray nozzle is a pulsating nozzle capable of delivering a pulsating flow of food colorant by delivery up to 10,000 beats per minute. Automatic spray guns also can be used to apply the food colorant. In general, persons skilled in the art are capable of selecting the proper spray equipment after considering the shape of the predetermined pattern, the desired degree of color for the foodstuff, and the coloring strength of the food colorant.

The following examples illustrate the present invention. In particular, a food colorant, e.g., MAILLOSE® (undiluted), was applied to chicken, pork, and toast, and provided esthetic food products having grill marks. The following tests were performed on commercial chicken mignon patties. The chicken patties are comminuted and reconstituted chicken meat.

### EXAMPLE 1

Application: MAILLOSE® (4%, by weight, HAA), in a line pattern, was sprayed, undiluted, onto frozen chicken patties. Impingement heat (400° F.) was applied to the treated patties for one minute. The patties still were frozen after the short heating step following the undiluted MAILLOSE® application. This amount of heating is sufficient to melt the frozen water on the surface of the foodstuff, thereby allowing a more efficient application of the food colorant. The patties then were frozen for 30 minutes.

Cooking: The treated and refrozen patties were cooked in convection oven at 350° F. to a 170° F. internal temperature.

Results: The chicken patties had faint golden brown lines that spread slightly, but were even in color.

### EXAMPLE 2

Application: MAILLOSE® (undiluted) was sprayed onto frozen, and unheated, chicken patties in a line pattern. The patties then were frozen for 30 minutes.

Cooking: The treated patties were cooked. in an impingement oven at 400° F. to a greater than 170° F. internal temperature.

Results: The chicken patties had dark to black lines that were very indicative of grill marks. The grill mark lines had less spreading, i.e., even more definite than the grill mark lines in Example 1.

### EXAMPLE 3

MAILLOSE® Dry (10%, by weight, HAA) was applied, undiluted, to a handmade chicken patties by a plastic pipette. The process produced a smattered grill line because the volume of applied MAILLOSE® Dry could not be controlled.

Cooking: The patties were cooked using impingement heat at 400° F. until the foodstuff reached a 170° F. internal temperature.

Results: The cooked chicken patties were brown in areas where the MAILLOSE® Dry was applied.

### EXAMPLE 4

Application: CHARSOL® Supreme (undiluted) was applied in a line pattern to frozen chicken patties. The treated patties then were frozen for 30 minutes.

Cooking: The patties were cooked using impingement heat at 350° F. until the foodstuff reach an internal temperature of greater than 170° F.

Results: The treated chicken patties had faint black lines that resembled ink smear. The width of the grill mark lines was relatively large.

### EXAMPLE 5

Application: CHARSOL® Supreme (undiluted) was applied in a line pattern onto frozen chicken patties.

Cooking: The treated chicken patties were cooked in an impingement oven at 400° F. to a greater than 170° F. internal temperature.

Results: The cooked chicken patties had dark black grill mark lines. There was some bleeding of the lines. However, the line width was acceptable esthetically and the color was pleasing.

The chicken patties of Examples 4 and 5 were sprayed using the same sprayer. The same pressure used in Example 4 was greater than the spray pressure used in Example 5. The patties of Example 5 had thinner grill mark lines with less spreading directly after the application. Spray pressure, therefore, may effect on the overall shape and definition of the grill marks.

### EXAMPLE 6

Application: CHARSOL® Supreme (undiluted) was applied in a line pattern onto frozen chicken patties. The treated patties were impingement heated at 400° F. for 1 minute, then frozen for 30 minutes.

Cooking: The treated chicken patties were cooked in convection oven at 350° F. to a 170° F. internal temperature.

Results: The results were similar to Example 4, but the patties were more esthetic, i.e., better grill line definition and width, and less bleeding.

### EXAMPLE 7

Application: A chicken patty was heated in impingement oven at 400° F. for 3 minutes. CHARSOL® Supreme (undiluted) then was sprayed onto the patty in a criss-cross pattern. The treated patty was not subjected to freezing conditions.

Cooking: The treated patty was cooked in an impingement oven at 400° F. to a greater than 170° F. internal temperature.

Results: The cooked patty had very tight, dark black grill mark lines, of very small width, lines. Pooling of CHARSOL® Supreme (undiluted) in areas produced spots, typically, but not exclusively, at the intersections of the criss-cross pattern. A preheat to remove surface frost prior to the spray application produced excellent results.

### EXAMPLE 8

Application: A frozen handmade chicken patty was sprayed with CHARSOL® Supreme (undiluted) in criss-cross pattern. The tested patty was not frozen after the treatment.

Cooking: The treated patty was cooked in an impingement oven at 400° F. to a greater than 170° F. internal temperature.

Results: The results were similar, but slightly inferior, to Example 7.

### EXAMPLE 9

Application: Example 2 was duplicated, except the chicken patty was impinge heated at 400° F. for 3 minutes prior to a spray application of MAILLOSE® (undiluted).

Results: The patty had slightly darker lines, and a narrower line width than the patties of Example 2 because of a slight preheating to remove surface frost.

### EXAMPLE 10

Application: Chicken patties were impinge heated at 400° F. for 3 minutes. MAILLOSE® (undiluted) then was sprayed onto the patties, followed by freezing for 30 minutes.

Cooking: The treated patties were deep fried in 375° F. oil for 7 minutes to a 170° F. internal temperature.

Results: Very esthetic, dark grill mark lines were observed. The chicken patties definitely had the appearance of a grilled product. The background of the patty also was browned, but not to the 5 same degree as the sprayed grill lines.

### EXAMPLE 11

Shrimp also was tested for application of grill marks. The test parameters were as follows.

Test Group A Shrimp

The shrimp were thawed in a soak solution of 1% salt, 2% sodium tripolyphosphate, and 97% water, by weight. The shrimp were block-frozen product with the tail on.

Test Group B Shrimp

The shrimp were individually quick-frozen (IQF) with the tail on. The shrimp were rinsed in hot water to remove surface frost.

Each of the following tests were performed on the shrimp of Group A and Group B.

| Test No. | Product Used | Procedure |
|---|---|---|
| 1 | MAILLOSE ® at | MAILLOSE ® was applied to the shrimp using a |
| | 100% (4% active | noncontact grill marker, i.e., a spray. The |
| | HAA) | shrimp then were cooked in an impingement oven |
| | | for 30 seconds at 250° F., and individually |
| | | quick-frozen for later reheating. |
| 2 | MAILLOSE ® at | The shrimp were cooked in an impingement oven |
| | 100% | for 30 seconds at 250° F. MAILLOSE ® then was |
| | | applied using a noncontact grill marker, and |
| | | the shrimp were individually quick-frozen for |
| | | later reheating. |
| 3 | MAILLOSE ® at | MAILLOSE ® was applied to the shrimp using a |
| | 100% | noncontact grill marker. The shrimp then was |
| | | cooked in an impingement oven for 30 seconds |
| | | at 500° F., and individually quick-frozen for |
| | | later reheating. |
| 4 | MAILLOSE ® at | The shrimp were cooked in an impingement oven |
| | 100% | for 30 seconds at 500° F. MAILLOSE ® was applied |
| | | using a noncontact grill marker, then |
| | | individually quick-frozen for later reheating. |
| 5 | MAILLOSE ® at | The shrimp were passed under compressed air to |
| | 100% | remove surface moisture. MAILLOSE ® was heated |
| | | to 160° F., then applied to the shrimp using a |
| | | noncontact grill marker. The shrimp were |
| | | individually quick-frozen for later reheating. |
| 6 | CHARSOL ® VSA at | CHARSOL ® VSA was applied to the shrimp using a |
| | 100% | noncontact grill marker. The shrimp then were |
| | (4 1/2% active | cooked in an impingement oven for 30 seconds |
| | HAA) | at 500° F., and individually quick-frozen for |
| | | later reheating. |
| 7 | CHARSOL ® VSA at | The shrimp were cooked in an impingement oven |
| | 100% | for 30 seconds at 500° F. CHARSOL ® VSA was |
| | | applied using a noncontact grill marker, then |
| | | the shrimp were individually quick-frozen for |
| | | later reheating. |
| 8 | CHARSOL ® | CHARSOL ® Supreme was applied to the shrimp |
| | Supreme at 100% | using a noncontact grill marker. The shrimp |
| | (5% active HAA) | were cooked in an impingement oven for 30 |
| | | seconds at 500° F., then individually quick- |
| | | frozen for later reheating. |
| 9 | CHARSOL ® | The shrimp were cooked in an impingement oven |
| | Supreme at 100% | for 30 seconds at 500° F. The CHARSOL ® Supreme |
| | | was applied using a noncontact grill marker, |
| | | then the shrimp were individually quick-frozen |
| | | for later reheating. |
| 10 | MAILLOSE ® 45 | A blend of MAILLOSE ® 45 and MAILLOSE ® was |
| | (25% active | applied to the shrimp using a noncontact grill |
| | HAA) combined | marker. The shrimp were cooked in an |
| | with MAILLOSE ® | impingement oven for 30 seconds at 250° F., then |
| | at 1 to 1 ratio | individually quick-frozen for later |
| | | reheating. |
| 11 | MAILLOSE ® 45 | The shrimp were cooked in an impingement oven |
| | combined with | for 30 seconds at 250° F. A blend of MAILLOSE ® |
| | MAILLOSE ® at 1 | 45 and MAILLOSE ® was applied using a noncontact |
| | to 1 ratio | grill marker, then the shrimp were |
| | | individually quick-frozen for later reheating. |
| 12 | MAILLOSE ® 45 | A blend of MAILLOSE ® 45 and MAILLOSE ® was |
| | combined with | applied to the shrimp using a noncontact grill |
| | MAILLOSE ® at 1 | marker. The shrimp were cooked in an |
| | to 1 ratio | impingement oven for 30 seconds at 500° F., then |
| | | individually quick-frozen for later reheating. |
| 13 | MAILLOSE ® 45 | The shrimp were cooked in an impingement oven |
| | combined with | for 30 seconds at 500° F. A blend of MAILLOSE ® |
| | MAILLOSE ® at 1 | 45 and MAILLOSE ® was applied using a noncontact |
| | to 1 ratio | grill marker, then the shrimp were individually |
| | | quick-frozen for later reheating. |

The following tests were performed using MAILLOSE® Dry applied manually to the two groups of shrimp.

| Test No. | Product Used | Procedure |
|---|---|---|
| 14 | MAILLOSE ® Dry | MAILLOSE ® Dry was applied to the shrimp. The |
| | at 100% (10% | shrimp then were cooked in an impingement oven |
| | active HAA) | for 30 seconds at 500° F., and individually quick- |
| | | frozen for later reheating. |
| 15 | MAILLOSE ® Dry | MAILLOSE ® Dry was applied to the shrimp. The |
| | at 100% | shrimp then were cooked in an impingement oven |
| | | for 30 seconds at 250° F., and individually quick- |
| | | frozen for later reheating. |
| 16 | MAILLOSE ® Dry | The shrimp were cooked in an impingement oven |
| | at 100% | for 30 seconds at 250° F. MAILLOSE ® Dry then was |
| | | applied and the shrimp were individually quick- |
| | | frozen for later reheating. |
| 17 | MAILLOSE ® Dry | The shrimp were passed under compressed air to |
| | at 100% | remove surface moisture. MAILLOSE ® Dry was |
| | | applied to the shrimp, then the shrimp were |
| | | individually quick-frozen for later reheating. |

The following chart summarizes the results from applying HAA on shrimp, as described above. These results are based on the color formation observed after the shrimp were cooked in an impingement oven from a frozen state.

| Test | | |
|---|---|---|
| No. | Group A Shrimp | Group B Shrimp |
| 1 | Clear light brown grill marks | Clear tan grill marks appeared |
| | appeared | |
| 2 | Defined brown grill marks | Defined brown grill marks |
| | appeared | appeared |
| 3 | Defined brown grill marks | Defined brown grill marks |
| | appeared | appeared |
| 4 | Defined brown-black grill | Defined brown-black grill marks |
| | marks appeared | appeared |
| 5 | Faint tan grill marks appeared | Faint tan grill marks appeared |
| 6 | Muddy brown grill marks | Muddy brown grill marks |
| | appeared | appeared |
| 7 | Muddy brown grill marks | Muddy brown grill marks |
| | appeared | appeared |
| 8 | Defined black grill marks | Defined black grill marks |
| | appeared, but the flavor was | appeared, but the flavor was |
| | strong. | strong. |
| 9 | Defined black grill marks | Defined black grill marks |
| | appeared, but the flavor was | appeared, but the flavor was |
| | strong. | strong. |
| 10 | Black, burn-like, grill marks | Black, burn-like, grill marks |
| | appeared. | appeared. |
| 11 | Black, burn-like, grill marks | Black, burn-like, grill marks |
| | appeared. | appeared. |
| 12 | Very defined black, burn-like, | Very defined black, burn-like, |
| | grill marks appeared. | grill marks appeared. |
| 13 | Very defined black, burn-like, | Very defined black, burn-like, |
| | grill marks appeared. | grill marks appeared. |
| 14 | Brown-black grill marks | Brown-black grill marks |
| | appeared | appeared |
| 15 | Brown grill marks appeared | Brown grill marks appeared |
| 16 | Brown grill marks appeared | Brown grill marks appeared |
| 17 | Brown grill marks appeared | Brown grill marks appeared |

A foodstuff treated with a food colorant according to the present invention can be cooked in a variety of ways to provide a predetermined pattern of grill marks on the food stuff. For example, the foodstuff can be deep fried, baked, microwaved, oven heated, or grilled.

### EXAMPLE 12

Application: RA97051, a food colorant available from Red Arrow Products Co., LLC, Manitowoc, Wis., was applied to frozen corn dogs by spraying. RA97051 has a pH 12 and is black in color. This color was transferred to the corn dogs when the RA97051 was applied to the corn dogs. The patterns on the frozen corn dogs were varied for identification. In one test, the lines were perpendicular on the corn dogs. In the other test, the lines were diagonal. The variable line patterns allowed differentiation between the corn dogs at an outlet on a roller grill as they were cooked.

Cooking: The treated corn dogs were heated at 350° F. for 2 minutes in a Lincoln Impingement oven to set the color.

Results: The food colorant reacted with the surface of the foodstuff to set the color without running or bleeding. The food colorant, because of its neutralization, did not impart a flavor to the finished product after cooking. The treated and heated corn dogs were refrozen for later consumption.

Obviously, many modifications and variations of the invention as hereinbefore set forth can be made without departing from the spirit and scope thereof, and, therefore, only such limitations should be imposed as are indicated by the appended claims.

1. A method of providing grill marks on a foodstuff comprising the steps of:
(a) providing a foodstuff;
(b) applying a food colorant to at least one surface of the foodstuff in a predetermined grill mark pattern to provide a treated foodstuff, wherein the food colorant is applied in the absence of contact between the foodstuff and an apparatus used to apply the food colorant to the foodstuff; and
(c) heating or cooking the treated foodstuff for a sufficient time at a sufficient temperature to generate grill marks on the foodstuff.

2. The method of claim 1 wherein the foodstuff is frozen.

3. The method of claim 2 wherein the foodstuff is raw.

4. The method of claim 2 wherein the foodstuff is precooked.

5. The method of claim 1 wherein the foodstuff is fresh.

6. The method of claim 5 wherein the foodstuff is raw.

7. The method of claim 5 wherein the foodstuff is precooked.

8. The method of claim 1 wherein the foodstuff is selected from the group consisting of seafood, chicken, beef, pork, a dough-based product, toast, polenta, a pet food, a snack food, and a cheese.

9. The method of claim 1 wherein the predetermined pattern is one or more straight lines.

10. The method of claim 1 wherein the predetermined pattern is one or a complex pattern.

11. The method of claim 1 wherein the food colorant is essentially undetectable to the human eye after application to the foodstuff in step (b).

12. The method of claim 1 wherein the food colorant comprises hydroxyacetaldehyde.

13. The method of claim 12 wherein the food colorant further comprises a food flavorant.

14. The method of claim 1 wherein the food colorant comprises a food dye, carbonyl compounds, or a mixture thereof.

15. The method of claim 1 wherein the treated foodstuff is cooked or heated by deep frying, baking, microwaving, toasting, infrared, oven heating, or grilling.

16. The method of claim 1 wherein the food colorant is applied by a sprayer.

17. The method of claim 1 wherein the food colorant is applied by dripping or gravity.

18. The method of claim 16 wherein the sprayer has a spraying orifice diameter of about 0.008 to about 0.123 inches.

19. The method of claim 16 wherein the sprayer delivers about 0.003 to about 2 gallons of food colorant per minute over a pressure range of 5 to 1500 pounds per square inch.

20. The method of claim 16 wherein the sprayer is a pulsating sprayer.

21. The method of claim 11 wherein the predetermined pattern of grill marks become visible during the cooking or heating step (c).

22. The method of claim 2 wherein the frozen foodstuff is treated prior to step (b) to melt or remove frozen surface moisture from the foodstuff.

23. The method of claim 22 wherein the treated foodstuff is subjected to freezing conditions after step (b).

24. The method of claim 22 wherein the treatment is a heating step or an application of compressed air.

25. A method of providing grill marks on a foodstuff comprising the steps of:
(a) providing a foodstuff;
(b) applying a food colorant to at least one surface of the foodstuff in a predetermined grill mark pattern to generate grill marks on the foodstuff, wherein the food colorant is applied in the absence of contact between the foodstuff and an apparatus used to apply the food colorant to the foodstuff; and
(c) optionally heating or cooking the foodstuff.
